(19) United States
(12) Patent Application Publication
(10) Pub. No.: US 2022/0179815 A1
(43) Pub. Date: Jun. 9, 2022

(54) Devices and Methods for Audio Signal Transmission from HDMI to USB-C

(71) Applicant: SYNG, Inc., Venice, CA (US)

(72) Inventors: Marc Carino, Venice, CA (US); Kevin Rowland, Venice, CA (US); Afrooz Family, Los Angeles, CA (US); Jay Sterling Coggin, Brooklyn, NY (US)

(73) Assignee: SYNG, Inc., Venice, CA (US)

(21) Appl. No.: 17/457,641

(22) Filed: Dec. 3, 2021

Related U.S. Application Data
(60) Provisional application No. 63/121,146, filed on Dec. 3, 2020.

(51) Int. Cl. G06F 13/38; G06F 13/40

(52) U.S. Cl. CPC G06F 13/385; G06F 13/4022

(57) ABSTRACT

Devices and methods for audio signal transmission from HDMI to USB-C in accordance with embodiments of the invention are illustrated. One embodiment includes a High-Definition Multimedia Interface (HDMI) to Universal Serial Bus Type C (USB-C) audio transmission cable, including, an HDMI connector, a USB-C connector, and a processing component, where the processing component is communicatively coupled to the HDMI connector and the USB-C connector, the processing component including a pattern generator, and an HDMI to USB-C signal converter, where the processing component is configured to: transmit a video pattern generated by the pattern generator via the HDMI connector, receive an HDMI audio signal via the HDMI connector over an Audio Return Channel (ARC) in response to the transmission of the video pattern, convert the HDMI audio signal into a USB-C audio signal using the HDMI to USB-C signal converter, and transmit the USB-C audio signal using the USB-C connector.

### CROSS-REFERENCE TO RELATED APPLICATIONS

The current application claims the benefit of and priority under 35 U.S.C. § 119(e) to U.S. Provisional Patent Application No. 63/121,146 entitled “Devices and Methods for Audio Signal Transmission from HDMI to USB-C” filed Dec. 3, 2020, the disclosure of which is hereby incorporated by reference in its entirety for all purposes.

### FIELD OF THE INVENTION

The present invention generally relates to transmission of audio signals from sources transmitting the signal via a High-Definition Multimedia Interface (HDMI) port to a Universal Serial Bus Type C (USB-C) port. More specifically, cables and other form factor connectors are described that provide this functionality.

### BACKGROUND

The High-Definition Multimedia Interface (HDMI) standard is a standard for data connectivity using a proprietary connector format. Universal Serial Bus Type C (USB-C) is one of the latest iterations of the USB standard which is a standard for data connectivity using a different proprietary connector format. HDMI Alternate Mode is a mode provided by HDMI that enables taking display data from a USB-C connector end of a cable and outputting it on an HDMI connector end of the cable.

### SUMMARY OF THE INVENTION

Devices and methods for audio signal transmission from HDMI to USB-C in accordance with embodiments of the invention are illustrated. One embodiment includes a High-Definition Multimedia Interface (HDMI) to Universal Serial Bus Type C (USB-C) audio transmission cable, including, an HDMI connector, a USB-C connector, and a processing component, where the processing component is communicatively coupled to the HDMI connector and the USB-C connector, the processing component including a pattern generator, and an HDMI to USB-C signal converter, where the processing component is configured to: transmit a video pattern generated by the pattern generator via the HDMI connector, receive an HDMI audio signal via the HDMI connector over an Audio Return Channel (ARC) in response to the transmission of the video pattern, convert the HDMI audio signal into a USB-C audio signal using the HDMI to USB-C signal converter, and transmit the USB-C audio signal using the USB-C connector.

In another embodiment, the ARC is an enhanced ARC (eARC).

In a further embodiment, the video pattern includes red, green, and blue pixel values.

In still another embodiment, the processing component further includes a digital signal processor.

In a still further embodiment, the digital signal processor transcodes audio data described by the HDMI audio signal from a first audio format to a second audio format.

In yet another embodiment, the digital signal processor transcodes audio data described by the USB-C audio signal from a first audio format to a second audio format.

In a yet further embodiment, the length of cable between the processing component and the USB-C includes a plurality of wires that only contains wires for carrying audio signals.

In another additional embodiment, a method for transmitting audio signals from a High-Definition Multimedia Interface (HDMI) output to a Universal Serial Bus Type C (USB-C) input includes transmitting a video pattern generated by a pattern generator embedded in a cable to an HDMI audio source device via an HDMI connector, receiving an HDMI audio signal at the HDMI connector of the cable over an Audio Return Channel (ARC) in response to the transmission of the video pattern, converting the HDMI audio signal into a USB-C audio signal using an HDMI to USB-C signal converter embedded in the cable, and transmitting the USB-C audio signal to a USB-C audio sink device.

In a further additional embodiment, the ARC is an enhanced ARC (eARC).

In another embodiment again, the video pattern includes red, green, and blue pixel values.

In a further embodiment again, the method further includes transcoding audio data described by the HDMI audio signal from a first audio format to a second audio format using a digital signal processor embedded in the cable.

In a yet further embodiment again, the method further includes transcoding audio data described by the USB-C audio signal from a first audio format to a second audio format using a digital signal processor embedded in the cable.

In still yet another embodiment, the length of cable between the processing component and the USB-C includes a plurality of wires that only contains wires for carrying audio signals.

In a still yet further embodiment, a home theater system includes a display device having a High-Definition Multimedia Interface (HDMI) port, an audio device having a USB-C port, and a cable connecting the display to the audio device using the HDMI port and the USB-C port, where the cable includes an HDMI connector at a first end of the cable configured to couple with the HDMI port, a USB-C connector at a second end of the cable configured to couple with the USB-C port, and a processing component, where the processing component is communicatively coupled to the HDMI connector and the USB-C connector, the processing component including a pattern generator, and an HDMI to USB-C signal converter, where the processing component is configured to: transmit a video pattern generated by the pattern generator via the HDMI connector to the display device, receive an HDMI audio signal via the HDMI connector over an Audio Return Channel (ARC) from the display device in response to the transmission of the video pattern, convert the HDMI audio signal into a USB-C audio signal using the HDMI to USB-C signal converter, and transmit the USB-C audio signal to the audio device using the USB-C connector.

In still another additional embodiment, the display device is a television.

In a still further additional embodiment, the audio device is a loudspeaker.

In still another embodiment again, the audio device is communicatively coupled to one or more loudspeakers.

In a still further embodiment again, the video pattern includes red, green, and blue pixel values.

In yet another additional embodiment, the processing component further includes a digital signal processor.

In a yet further additional embodiment, the digital signal processor transcodes audio data described by the HDMI audio signal from a first audio format to a second audio format.

In yet another embodiment again, the digital signal processor transcodes audio data described by the USB-C audio signal from a first audio format to a second audio format.

Additional embodiments and features are set forth in part in the description that follows, and in part will become apparent to those skilled in the art upon examination of the specification or may be learned by the practice of the invention. A further understanding of the nature and advantages of the present invention may be realized by reference to the remaining portions of the specification and the drawings, which forms a part of this disclosure.

### BRIEF DESCRIPTION OF THE DRAWINGS

The description and claims will be more fully understood with reference to the following figures and data graphs, which are presented as exemplary embodiments of the invention and should not be construed as a complete recitation of the scope of the invention.

FIG. 1 illustrates a use case for an HDMI to USB-C Audio Transmission Cable in accordance with an embodiment of the invention.

FIG. 2 is a conceptual block diagram for an HDMI to USB-C Audio Transmission Cable in accordance with an embodiment of the invention.

FIG. 3 is a communication diagram illustrating signal flow in a system using an HDMI to USB-C Audio Transmission Cable in accordance with an embodiment of the invention.

FIG. 4 is a flow chart for a process for enabling HDMI to USB-C audio transmission in accordance with an embodiment of the invention.

FIG. 5 is a block diagram for an implementation of an HDMI to USB-C Audio Transmission Cable in accordance with an embodiment of the invention.

FIG. 6 is a block diagram for another implementation of an HDMI to USB-C Audio Transmission Cable in accordance with an embodiment of the invention.

### DETAILED DESCRIPTION

Both HDMI compliant and USB-C compliant cables are commonly found. Both standards are useful for transferring data between devices. HDMI is typically used for transmitting media data such as movies and music between HDMI source devices and HDMI display devices. For example, many video game consoles and optical media players have HDMI outputs that connect to HDMI inputs on televisions. USB-C is typically found on portable consumer electronics devices and computers and is used for transmitting various types of data and/or power for charging. Because many individuals would like to use their phones, tablets, and computers as media source devices for their televisions and other monitors, HDMI Licensing Administrator, Inc. has released the HDMI Alternate Mode specification which enables the creation of a cable which has an HDMI connector on one end and a USB-C connector on the other.

The HDMI Alternate Mode specification is specifically for using the device connected to the USB-C end of the cable as a media source for providing media data to a display device connected at the HDMI end. From a consumer standpoint, such a cable solves many problems such as using a smartphone to play movies on a television without having to connect to a wireless network. The HDMI Alternate Mode specification can also enable Audio Return Channel (ARC) and enhanced ARC (eARC) functionality as described in the HDMI specification. ARC and eARC enable audio to be passed from a display device receiving an HDMI signal (referred to as an HDMI sink) back to the device providing the HDMI signal (referred to as an HDMI source). While this is useful for reducing the number of cables needed in most systems, it fails to address the needs of audio systems which want to receive audio from a display device without acting as an HDMI source.

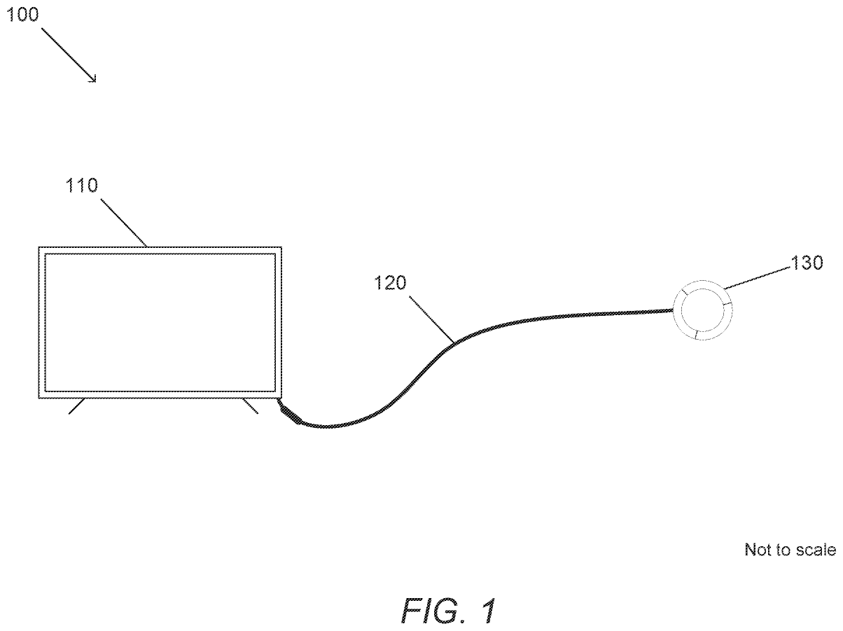

Devices and methods described herein can enable an audio system to receive an ARC or eARC signal from a display device (such as, but not limited to, a television, a monitor, projector, or any other type of display) without acting as an HDMI source. In many embodiments, an HDMI to USB-C Audio Transmission Cable is used which enables an audio device (e.g. a speaker) with a USB-C port to receive audio data from a display device with an HDMI port without requiring the audio device to act as an HDMI source. In numerous embodiments, the HDMI to USB-C Audio Transmission Cable includes a component which can transcode the audio signal from one file format to another file format. This can enable audio systems without the necessary codecs to playback a particular audio format transmitted by the display device to receive the audio data in a playable format. Turning now to the drawings, an example system using an HDMI to USB-C Audio Transmission Cable in accordance with an embodiment of the invention is illustrated in FIG. 1.

Entertainment system 100 includes a display device 110. In the instant illustration, the display device 110 is a television, although the display device can in fact be any device that has audio data and an HDMI output such as (but not limited to) monitors, game consoles, Blu-ray players, DVD players, and/or any other device having audio data and an HDMI port as appropriate to the requirements of specific applications in accordance with various embodiments of the invention. An HDMI to USB-C Audio Transmission Cable 120 connects the display device 110 and an audio device 130. In many embodiments, the audio devices are cells such as those described in U.S. patent application Ser. No. 16/839,021 titled “Systems and Methods for Spatial Audio Rendering,” the entirety of which is incorporated herein by reference. However, audio devices can be any audio output device such as, but not limited to, soundbars, loudspeakers, audio amplifiers, and/or any other device attempting to extract an audio signal from the display device as appropriate to the requirements of specific applications of embodiments of the invention.

Additionally, while the HDMI to USB-C Audio Transmission Cable is referred to as a cable, it is not a requirement for a cable to be the form factor. In many embodiments, boxes, dongles, and/or other implementations can be used as appropriate to the requirements of specific applications of embodiments of the invention. The below section discusses HDMI to USB-C Audio Transmission Cables in further detail, but as can be readily appreciated, similar components can be integrated into a wide array of non-cable formed connectors.

### HDMI to USB-C Audio Transmission Cables

HDMI to USB-C Audio Transmission Cables can take audio from a display device having an HDMI port and transmit audio data to an audio device having a USB-C cable. In many embodiments, the HDMI to USB-C Audio Transmission Cable only carries audio signals, although it is not a requirement. Further, HDMI to USB-C Audio Transmission Cables can transcode audio data from one format to another. For example, in many embodiments, an HDMI to USB-C Audio Transmission Cable can transcode audio encoded in the Dolby Atmos format to MP4 or any other format as appropriate to the requirements of specific applications of embodiments of the invention. In some embodiments, the input format is transcoded to an ambisonic format.

In many embodiments, encrypted content is transmitted along HDMI to USB-C Audio Transmission Cables. Encrypted content can be decrypted, transcoded, and re-encrypted by the Cable. For example, in various embodiments, transcoding audio involves operating on unencrypted (or decrypted) content. In numerous embodiments, HDMI to USB-C Audio Transmission Cables are High-bandwidth Digital Content Protection (HDCP) compliant. However, any number of different encryption schemes can be accommodated as appropriate to the requirements of specific applications of embodiments of the invention.

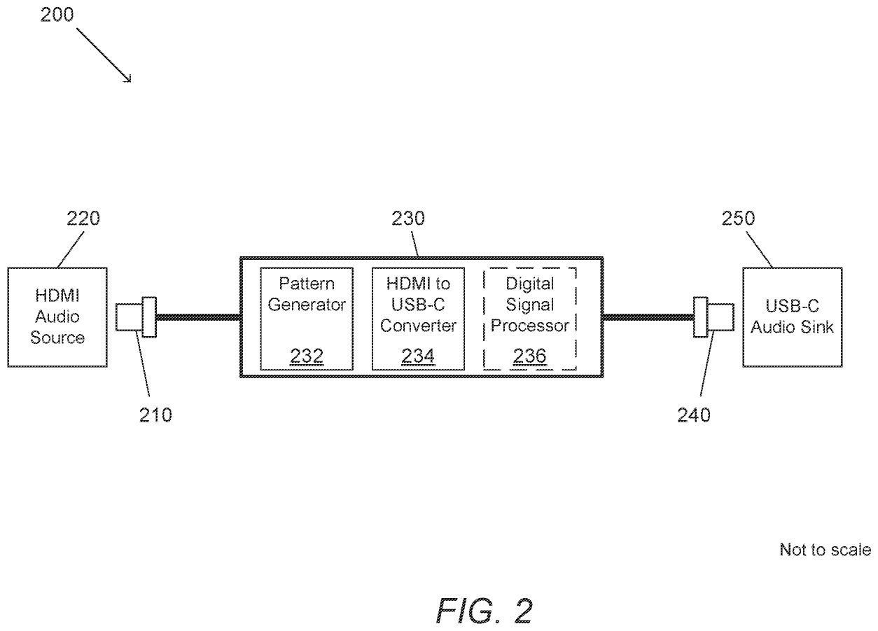

Turning now to FIG. 2, an HDMI to USB-C Audio Transmission Cable in accordance with an embodiment of the invention is illustrated. Cable 200 includes an HDMI connector 210. The HDMI connector 210 is capable of being connected to the HDMI port of an audio source 220. The cable 200 includes a processing component 230. In numerous embodiments, the processing component is fully integrated into the cable. The processing component contains a pattern generator 232. In many embodiments, pattern generators can generate HDMI-compliant video signals. In various embodiments, the pattern generator generates an arbitrary pattern. In numerous embodiments, it is not important as to what the actual visual content of the video signal is. The pattern generator 232 transmits the video signal to the audio source via the HDMI connector 210. Doing so can trigger the HDMI audio source to turn on ARC or eARC transmission, and triggers the transmission of the audio signal to the processing component 230. Further, in many embodiments, the integrated pattern generator enables the USB-C end of the cable to not require wires for connecting to video signal transmission pins. This can save considerable cost during manufacturing.

The processing component 230 further contains an HDMI to USB-C converter 234. HDMI to USB-C converters can convert an HDMI compliant signal into a USB-C compliant signal. Because HDMI and USB-C use different pin configurations, signals received in HDMI compliant format on HDMI compliant wiring on the HDMI side of the cable can be converted to USB-C compliant format on USB-C compliant wiring on the USB-C side of the cable.

In many embodiments, the processing component 230 further includes a digital signal processor 236. Digital signal processors can convert input audio in one format to another format. In various embodiments, the transcode is predetermined by the hardware configuration. In numerous embodiments, the digital signal processor can receive a request for a particular output format, and transcode into that particular format. In many embodiments, the processing component includes encryption and/or decryption components for encrypting and/or decrypting transmitted data.

The cable 200 further includes a USB-C connector 240 which can be connected to a USB-C port on an audio device (e.g. an audio sink). In many embodiments, the audio device can playback the received audio signal. Again, as can be readily appreciated, while a cable is illustrated, the form factor of the device is not important, and can be made in any shape or form as appropriate to the requirements of specific applications of embodiments of the invention. Processes performed by the cable are discussed in further detail below.

### Audio Transmission Processes

HDMI to USB-C Audio Transmission Cables can perform audio transmission processes that trigger display devices to act as HDMI sinks, thereby enabling them to transmit audio via the ARC or eARC channel without in fact being an HDMI sink. However, similar processes can be performed without the use of a cable. For example, a computer can be used to transmit signals via an HDMI to USB-C cable and take on many of the actions of processing components of a cable. Therefore, while processes using cables are discussed below, as can readily be appreciated, computers can perform similar processes without departing from the scope or spirit of the invention.

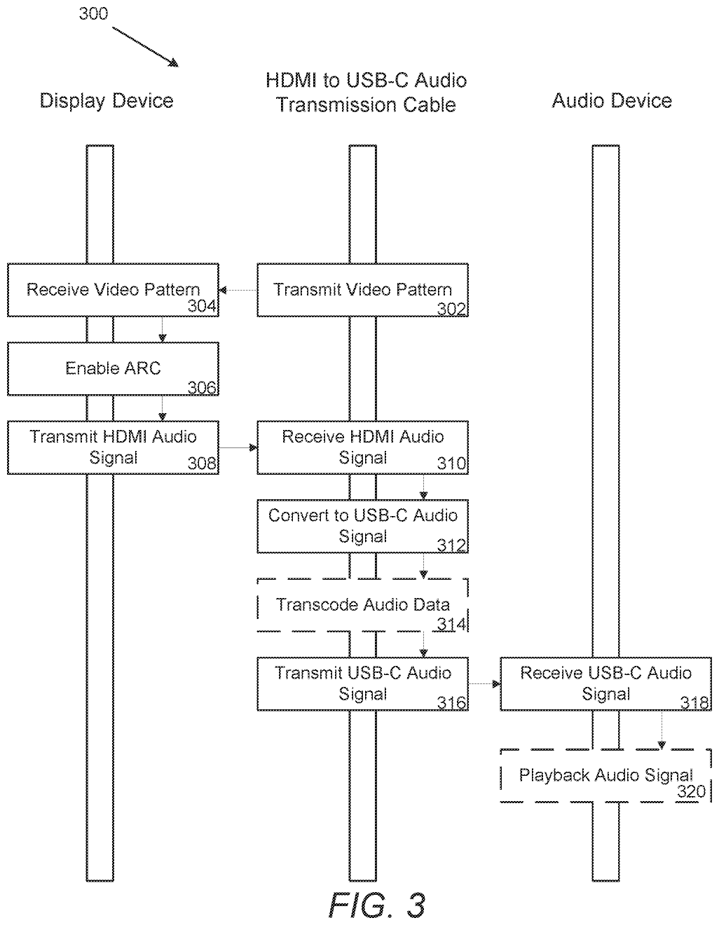

Turning now to FIG. 3, a communication diagram illustrating signal flow in a system using an HDMI to USB-C Audio Transmission Cable in accordance with an embodiment of the invention is illustrated. Communication flow 300 begins with the HDMI to USB-C Audio Transmission Cable transmitting (302) a video pattern to a display device via an HDMI connection. The display device receives (304) the video pattern and, in response, believes it is an HDMI sink and establishes (306) an ARC or eARC connection. The display device then transmits (308) HDMI audio over the ARC channel through the HDMI connection to the HDMI to USB-C Audio Transmission Cable.

The HDMI to USB-C Audio Transmission Cable then receives (310) the HDMI audio signal and converts it to a USB-C audio signal. In many embodiments, the HDMI to USB-C Audio Transmission Cable transcodes (314) the audio data in the audio signal into a different format. However, in numerous embodiments, the transcoding occurs using the HDMI audio signal and the subsequent transcoded HDMI audio signal is converted to an USB-C audio signal. As can be readily appreciated, the ordering or removal of certain steps can be performed as appropriate to the requirements of specific applications of embodiments of the invention.

The HDMI to USB-C Audio Transmission Cable can then transmit (316) the USB-C audio signal to the audio device via a USB-C connection. The audio device receives (318) the USB-C audio signal Audio data can then be received (420), and in many embodiments, the audio device plays back (320) the audio signal.

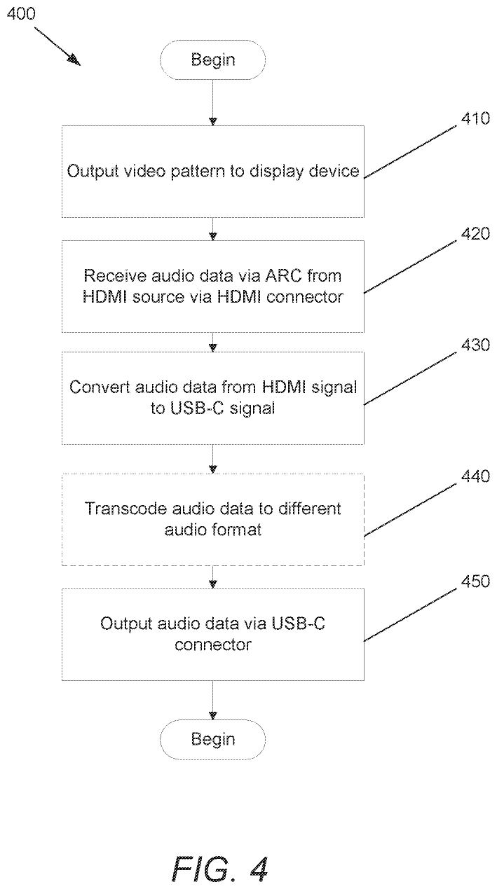

Turning now to FIG. 4, an audio transmission process for enabling HDMI to USB-C audio transmission in accordance with an embodiment of the invention is illustrated. Process 400 includes outputting (410) a video pattern to a display device via an HDMI port. In many embodiments, the video pattern is merely a simple pattern. Receiving the video pattern triggers the display device to act as an HDMI sink in accordance with the HDMI specification. As the display device is acting as an HDMI sink, an ARC or eARC connection can be established over the HDMI connection and audio data can be received (420). The audio data is converted (430) from an HDMI signal to a USB-C signal. In many embodiments, the audio data is transcoded (440) into a different format. In some embodiments, the transcoding involves converting into a different file format. In numerous embodiments, the transcoding involves upmixing or downmixing the audio data to have a different number of channels. In various embodiments, the transcode occurs when the audio data is still in HDMI form. Further, audio data can be decrypted prior to transcoding, and the transcoded audio data can be re-encrypted. The audio data in USB-C form, whether transcoded or not, is output (450) via a USB-C connection.

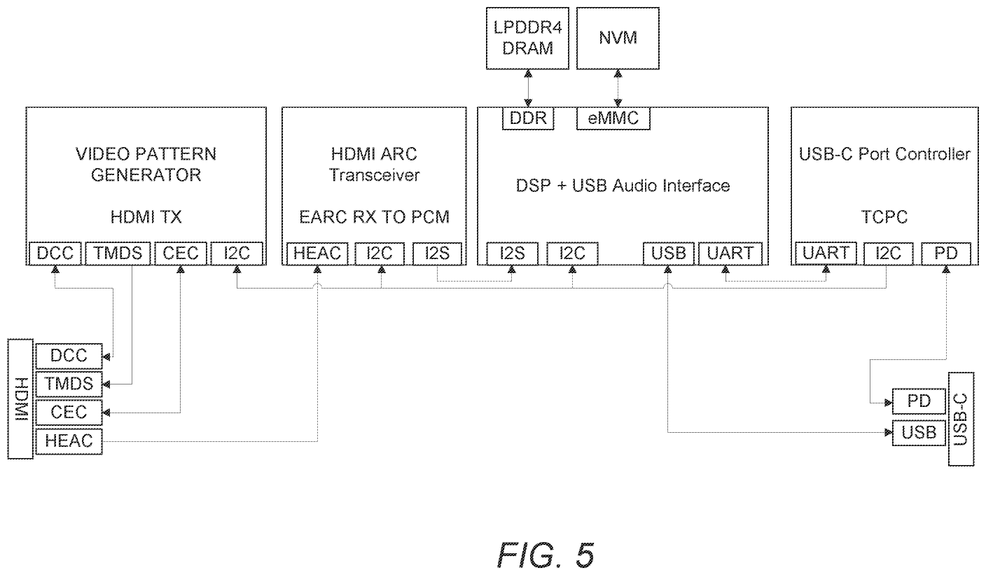

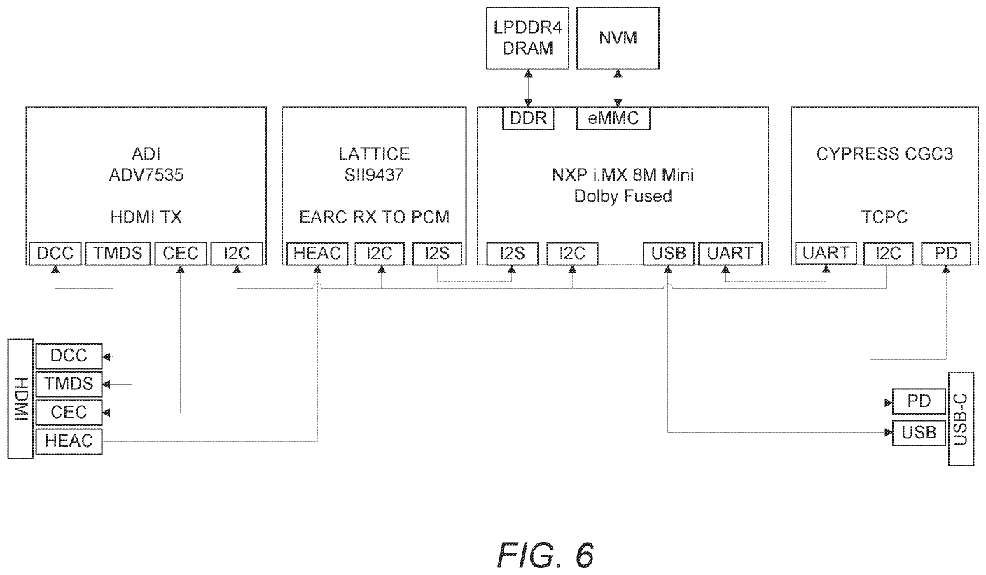

Although devices and methods for HDMI to USB-C audio transmission are discussed above, many different device constructions and methods can be implemented in accordance with many different embodiments of the invention. For example, turning now to FIGS. 5 and 6, various implementations of HDMI to USB-C audio transmission cables in accordance with two embodiments of the invention are illustrated. It is therefore to be understood that the present invention may be practiced in ways other than specifically described, without departing from the scope and spirit of the present invention. Thus, embodiments of the present invention should be considered in all respects as illustrative and not restrictive. Accordingly, the scope of the invention should be determined not by the embodiments illustrated, but by the appended claims and their equivalents.

What is claimed is:

1. A High-Definition Multimedia Interface (HDMI) to Universal Serial Bus Type C (USB-C) audio transmission cable, comprising:
an HDMI connector;
a USB-C connector; and
a processing component, where the processing component is communicatively coupled to the HDMI connector and the USB-C connector, the processing component comprising:
a pattern generator; and
an HDMI to USB-C signal converter;
where the processing component is configured to:
transmit a video pattern generated by the pattern generator via the HDMI connector;
receive an HDMI audio signal via the HDMI connector over an Audio Return Channel (ARC) in response to the transmission of the video pattern;
convert the HDMI audio signal into a USB-C audio signal using the HDMI to USB-C signal converter; and
transmit the USB-C audio signal using the USB-C connector.

2. The HDMI to USB-C audio transmission cable of claim 1, wherein the ARC is an enhanced ARC (eARC).

3. The HDMI to USB-C audio transmission cable of claim 1, wherein the video pattern comprises red, green, and blue pixel values.

4. The HDMI to USB-C audio transmission cable of claim 1, wherein the processing component further comprises a digital signal processor.

5. The HDMI to USB-C audio transmission cable of claim 4, where the digital signal processor transcodes audio data described by the HDMI audio signal from a first audio format to a second audio format.

6. The HDMI to USB-C audio transmission cable of claim 4, where the digital signal processor transcodes audio data described by the USB-C audio signal from a first audio format to a second audio format.

7. The HDMI to USB-C audio transmission cable of claim 1, wherein the length of cable between the processing component and the USB-C comprises a plurality of wires that only contains wires for carrying audio signals.

8. A method for transmitting audio signals from a High-Definition Multimedia Interface (HDMI) output to a Universal Serial Bus Type C (USB-C) input, comprising:
transmitting a video pattern generated by a pattern generator embedded in a cable to an HDMI audio source device via an HDMI connector;
receiving an HDMI audio signal at the HDMI connector of the cable over an Audio Return Channel (ARC) in response to the transmission of the video pattern;
converting the HDMI audio signal into a USB-C audio signal using an HDMI to USB-C signal converter embedded in the cable; and
transmitting the USB-C audio signal to a USB-C audio sink device.

9. The method for transmitting audio signals from an HDMI output to a USB-C input of claim 8, wherein the ARC is an enhanced ARC (eARC).

10. The method for transmitting audio signals from an HDMI output to a USB-C input of claim 8, wherein the video pattern comprises red, green, and blue pixel values.

11. The method for transmitting audio signals from an HDMI output to a USB-C input of claim 8, further comprising transcoding audio data described by the HDMI audio signal from a first audio format to a second audio format using a digital signal processor embedded in the cable.

12. The method for transmitting audio signals from an HDMI output to a USB-C input of claim 8, wherein the length of cable between the processing component and the USB-C comprises a plurality of wires that only contains wires for carrying audio signals.

13. A home theater system, comprising:
a display device having a High-Definition Multimedia Interface (HDMI) port;
an audio device having a USB-C port; and
a cable connecting the display to the audio device using the HDMI port and the USB-C port, where the cable comprises:
an HDMI connector at a first end of the cable configured to couple with the HDMI port;
a USB-C connector at a second end of the cable configured to couple with the USB-C port; and
a processing component, where the processing component is communicatively coupled to the HDMI connector and the USB-C connector, the processing component comprising:
a pattern generator; and
an HDMI to USB-C signal converter;
where the processing component is configured to:
transmit a video pattern generated by the pattern generator via the HDMI connector to the display device;
receive an HDMI audio signal via the HDMI connector over an Audio Return Channel (ARC) from the display device in response to the transmission of the video pattern;
convert the HDMI audio signal into a USB-C audio signal using the HDMI to USB-C signal converter; and
transmit the USB-C audio signal to the audio device using the USB-C connector.

14. The home theater system of claim 13, wherein the display device is a television.

15. The home theater system of claim 13, wherein the audio device is a loudspeaker.

16. The home theater system of claim 13, wherein the audio device is communicatively coupled to one or more loudspeakers.

17. The home theater system of claim 13, wherein the video pattern comprises red, green, and blue pixel values.

18. The home theater system of claim 13, wherein the processing component further comprises a digital signal processor.

19. The home theater system of claim 13, where the digital signal processor transcodes audio data described by the HDMI audio signal from a first audio format to a second audio format.

20. The home theater system of claim 13, where the digital signal processor transcodes audio data described by the USB-C audio signal from a first audio format to a second audio format.
